(19) United States
(12) Patent Application Publication
(10) Pub. No.: US 2015/0167181 A1
(43) Pub. Date: Jun. 18, 2015

(54) Synthesis of Molybdenum Catalyst Formulations for Hydrogen Generation

(71) Applicants: Timothy D. Vaden, Glassboro, NJ (US); Kandalam V. Ramanujachary, Glassboro, NJ (US); Amos Mugweru, Glassboro, NJ (US); Jyothirmayee Aravind, Glassboro, NJ (US)

(72) Inventors: Timothy D. Vaden, Glassboro, NJ (US); Kandalam V. Ramanujachary, Glassboro, NJ (US); Amos Mugweru, Glassboro, NJ (US); Jyothirmayee Aravind, Glassboro, NJ (US)

(21) Appl. No.: 14/108,292

(22) Filed: Dec. 16, 2013

(51) Int. Cl. C25B 1/04; H01M 4/90

(52) U.S. Cl. CPC C25B 1/04; H01M 4/9083

(57) ABSTRACT

The inventions relate to a process for making a platinum-free metal oxide/graphene catalyst by simultaneous reduction of a metal salt and a graphite oxide into a metal oxide and graphene for hydrogen production. The process includes (i) mixing the metal salt and the graphite oxide (GO) in water to form a metal salt-GO composite; and (ii) irradiating the metal salt-GO composite with focused solar light to spontaneously form the metal oxide/graphene catalyst.

### TECHNICAL FIELD

The field of the invention generally relates to platinum-free hydrogen evolution reaction (HER) catalysts containing molybdenum for electrolytic reduction of water. The HER catalyst material includes a MoO₂/graphene catalyst or a molybdenum phosphide (MoP) catalyst, and exhibits high activity to hydrogen generation. The MoO₂/graphene catalyst of the invention is made by chemical free co-reduction of graphite oxide (GO) and either ammonium tetrathiomolybdate (ATM) or ammonium heptamolybdate. The MoP catalyst of the invention is obtained by ball milling of commercial MoP (99.5%, Alfa Aesar) from 15 min to 90 min.

### BACKGROUND

The increasing demand for hydrogen arises from an imminent paradigm shift to a hydrogen-based energy economy, such as hydrogen fuel cells. This shift approaches as the world wide need for more electricity increases, greenhouse gas emission controls tighten, and fossil fuel reserves wane. A hydrogen-based economy is the only long term, environmentally benign alternative for sustainable growth because water is the sole side product of the combustion of hydrogen to generate heat and mechanical energy or the utilization of hydrogen in fuel cells. Over the last few years it is becoming more apparent that the emphasis on cleaner fuels will lead to the use of hydrogen in a significant way. Renewable energy sources, such as hydroelectricity and solar energy, impose no environmental threats by providing hydrogen through decomposition of water.

However, realization of a hydrogen economy provides a greater challenge due to the lack of energy efficient and cost effective techniques for the production of hydrogen. A sustained production process with renewable and economically viable materials is required for a green hydrogen economy. Current methods for producing hydrogen gas are predominantly based on fossil fuels, with about 95% based on fossil fuels and about 4% based on the electrolysis of water. This skew towards use of fossil fuels prevents a hydrogen economy to “go green.”

Catalytic electrolysis of water using a low over potential HER catalyst material is one of the most efficient methods for producing hydrogen. Platinum is one of the major HER catalyst materials known in the art due to its ability to provide a low over potential. However, the high cost and limited reserve of platinum prevents its use on a commercial scale. Therefore, there is a growing demand for cheap and abundant materials for use as HER catalysts on a commercial scale. The accomplishment of economic and large scale synthesis of catalytic material is a major topic of interest in the area of hydrogen production. To date, the attempts for the production of catalysts for hydrogen were mainly by high temperature chemical reactions, or those involving sophisticated instruments.

The present invention provides a process for a simple, fast, economic, and large scale production of an earth abundant MoO₂/graphene catalyst using an environmentally benign technique. An efficient and economically viable HER catalyst according to the invention is made by a green route. Molybdenum is one of the major, relatively abundant non-precious metals, which advantageously is much less expensive than platinum. Molybdenum disulfides (MoS₂) (Lukowski et al., J. of Am. Chem. Soc., 2013, 135 (28), 10274-10277)], core shell MoO₃—MoS₂ nanowires [Chen et al., Nano Lett. 2011, 11, 4168-4175), and MoO₃ nanowires (Phuruangrat et al., Electrochemistry Communications 11 (2009) 1740-1743) have been reported as hydrogen production catalysts. However, each of these has drawbacks. For example, the efficiency of MoS₂ as an HER catalyst depends upon a number of active edge sites and hence most reports of MoS₂ involve special techniques to engineer the surface of MoS₂. The method of synthesis of MoO₃ nanowires involves the use of surfactants and prolonged reaction timings A MoS₂/graphene hybrid is reported for hydrogen evolution, but the solovothermal reaction involves the reduction of molybdate salt and graphite oxide in DMF using a harmful chemical such as hydrazine (Li et at., J. of Am. Chem. Soc. 2011, 133, 7296-7299).

The present invention provides a novel method of synthesis of MoO₂ dispersed graphene by a single step, co-reduction of ammonium tetrathiomolybdate (ATM) and graphite oxide (GO), in the absence of any chemicals and/or reducing agents. As described in more detail herein, in the synthesis, a localized thermal irradiation of ATM-GO composite reduces ATM into molybdenum oxide (MoO₂) and GO into solar exfoliated graphene (SEG).

The present invention further provides a method for improving the hydrogen evolution properties of commercial MoP catalyst (C-MoP) by increasing its surface area through ball milling the catalyst in a conventional ball mill container with WC balls.

### SUMMARY

The present invention provides a novel synthesis of an HER catalyst material comprising molybdenum oxide/graphene. The present invention provides a green and economic route for large scale synthesis of a molybdenum oxide/graphene composite in a synthesis involving the simultaneous reduction of a molybdenum salt and graphite oxide into metal oxide dispersed graphene, using an energy efficient technique.

In one general aspect of the invention, there is provided a process for making platinum free metal oxide/graphene catalyst by simultaneous reduction of a metal salt and a graphite oxide into a metal oxide and graphene. The process includes the steps of
(a) mixing the metal salt and the graphite oxide (GO) in solvent such as water to form a metal salt-GO composite; and
(b) irradiating the metal salt-GO composite with focused solar light to spontaneously form the metal oxide/graphene catalyst.

Embodiments of the process may include one or more of the following features. For example, the process may further include isolating the metal salt-GO complex by removing the water (e.g., water) and grinding the resulting dry powder. The solvent, such as water, may be removed by slow heating in air at ˜50° C.

The focused solar light may be obtained using a convex lens of about 100 mm diameter. The conversion of the metal salt-GO composite to metal oxide-graphene may occur spontaneously and with no time lag between the irradiation of sunlight and reduction of the composite. The metal salt may be ammonium tetrathiomolybdate (ATM) or ammonium heptamolybdate.

The graphite oxide is reduced to graphene. The graphene may be obtained as solar exfoliated graphene.

The metal salt-GO composite may be a ATM-GO composite. The ATM-GO composite may be reduced to a 0.5 MoO₂/SEG complex. The MoO₂/SEG complex may contain trace amounts of sulfur.

The metal salt-GO composite may be an ammonium heptamolybdate-GO composite. The ammonium heptamolybdate-GO composite may be reduced to 0.5 MoO₂/SEG-H complex. The 0.5 MoO₂/SEG-H complex may be free of sulfur.

In another general aspect, the invention relates to a process for increasing the catalytic activity of a MoP (C-MoP) catalyst for providing generation of hydrogen. The process includes ball milling C-MoP in a ball mill to reduce the particle size of the MoP.

Embodiments of the process may include one or more of the following features. For example, the C-MoP may be ball milled for a period of between 10-60 minutes. The C-MoP may be ball milled for about 60 minutes. The MoP may have a particle size of less than about 200 nm and, more particularly, less than about 150 microns.

In another general aspect, the invention relates to a method of generating hydrogen, the method comprising using MoP having a particle size of less than 200 nm as a catalyst in a cathode. The MoP may have a particle size of less than about 150 nm.

In another general aspect, the invention relates to a method of generating hydrogen by using MoO₂/SEG as a catalyst in a cathode used for generating hydrogen.

Powder X-ray Diffractogram (XRD), Scanning Electron Microscope (SEM) analysis, and Energy Dispersive X-ray analysis (EDX) show simultaneous reduction of the molybdenum salt, ammonium tetrathiomolybdate (ATM), and graphite oxide (GO) and the formation of hybrid nanocomposites. Further, the BET surface area measurements show that the resulting compound exhibits a very high surface area.

The present invention further provides a novel method for improving the hydrogen evolution properties of MoP catalyst by ball milling the catalyst for about 15-90 minutes to reduce the particle size of the catalyst. Broad XRD peaks for milled MoP compared to commercially available MoP demonstrate the reduced particle size and increased surface area for the milled MoP catalyst leading to its improved hydrogen evolution properties.

Phuruangrat et al. (Phuruangrat et al., Electrochemistry Communications 11 (2009) 1740-1743) and Li et al. (Li et al., J. of Am. Chem. Soc. 2011, 133, 7296-7299) report conventional methods for making metal oxide or sulfide loaded composites for hydrogen production using chemical reducing agents. In contrast to these reports, the present invention provides a novel single step chemical synthesis of metal oxide loaded graphene composites without the use of a chemical/reducing agent.

In another aspect, the invention further provides a single step process to improve hydrogen evolution properties of MoP catalyst by ball milling the catalyst to reduce its particle size and increase its surface area. Therefore, in one embodiment of the invention, the hydrogen evolution properties of the MoP catalyst are improved by ball milling the catalyst for about 15-90 minutes in a ball mill container with WC balls.

In another embodiment of the invention, MoO₂/graphene is prepared by co-reduction of ATM-GO (ammonium tetrathiomolybdate-graphite oxide) composite using focused solar radiation. The resulting MoO₂/graphene complex contains trace amounts of sulfur from the ATM component.

In another, related embodiment of the invention, MoO₂/graphene-H is prepared by co-reduction of ammonium heptamolybdate-GO composite using focused solar radiation.

In another embodiment of the invention, the ATM-GO composite is prepared by mixing ATM and GO in deionized water and evaporating the solvent by slow heating at ˜50° C.

In yet another embodiment of the invention, pure ammonium tetrathiomolybdate (ATM) and pure graphite oxide (GO) are individually reduced to MoO₂ and solar exfoliated graphene (SEG) using focused solar radiation and compared with the products from the reduction of metal salts and GO in the synthesis of MoO₂/SEG catalyst.

In another embodiment of the invention, the XRD of MoO₂/graphene is compared with the XRD of pure molybdenum oxide (formed by solar irradiation of pure ATM) to confirm the formation of molybdenum oxide as molybdenum dioxide rather than molybdenum oxide monohydrate.

In another embodiment of the invention, the reduction of thick flakes of GO (graphite oxide) into thin layers SEG (solar exfoliated graphene) is shown by Scanning Electron Micrograph (SEM).

The novel synthetic method has at least the following advantages over the existing methods for the preparation of metal sulfide/oxide compounds for hydrogen generation:

i) simultaneous reduction of a metal salt (ATM) and graphite oxide (GO) by focused solar radiation for the preparation of metal oxide dispersed graphene nanocomposites;

ii) Rapid preparation of metal oxide/graphene nanocomposites provides spontaneous reduction of water which can be used for continuous production of hydrogen;

iii) high surface area of metal oxide dispersed graphene increases the optimal activity of the compound;

iv) a sustainable and economically viable production of hydrogen;

v) a green process for producing hydrogen without any use of harmful chemicals;

vi) a dry chemical reaction without any release of solvent effluents; and

vii). use of focused solar energy to save electricity and time, and reduce manpower, thereby making the process suitable for commercialization.

Other features and advantages of the invention will be apparent from the description, the drawings, and the claims.

### DESCRIPTION OF THE DRAWINGS

FIG. 1 is a simple pictorial illustration depicting the preparation of an ATM-GO composite.

FIG. 2(a) is a pair of photographs of ATM-GO before reduction using sunlight and focusing of sunlight using a convex lens (100 mm).

FIG. 2(b) is a pair of photographs showing the volume expansion of MoO₂/SEG formed after the reduction of ATM/GO.

FIG. 3 is a set of powder X-ray diffractograms of 0.5 ATM/GO, 0.5 MoO₂/SEG and commercial MoO₂ (C—MoO₂) composites

FIG. 4 is a powder X-ray diffractogram of ATM and pure MoO₂ formed by solar irradiation of ATM.

FIGS. 5(a) and 5(b) are scanning electron microscope (SEM) images of 0.5 MoO₂/SEG at two magnifications with FIG. 5(a) being on the left and FIG. 5(b) being on the right.

FIG. 5(c) is an EDX spectrum of the 0.5 MoO₂/SEG of FIGS. 5(a) and (b).

FIG. 6 shows cyclic voltammograms (CV) of bare glassy carbon electrode (GCE), solar exfoliated graphene (SEG), pure MoO₂, and 0.5 MoO₂/SEG vs Ag/AgCl electrode at 50 mV/s scan rate in 0.5 M H₂SO₄.

FIG. 7 shows linear sweep voltammograms (LSV) of bare glassy carbon electrode (GCE) along with 10% platinum/carbon, solar exfoliated graphene (SEG), pure MoO₂, and 0.5 MoO₂/SEG vs. Ag/AgCl electrode at 2 mV/s scan rate in 0.5 M H₂SO₄.

FIG. 8 is a Tafel plot of 0.5 MoO₂/SEG.

FIG. 9 is a gas chromatogram of 0.5 MoO₂/SEG recorded at different operating potentials and time.

FIG. 10 is an amperometric graph of 0.5 MoO₂/SEG coated electrode in sulfate buffer solution (pH 1) over a period of 20 hours.

FIG. 11 shows linear voltammograms of 0.5 MoO₂/SEG and 0.5 MoO₂/SEG-H at 2 mV/s scan rate in 0.5 M H₂SO₄.

FIG. 12 shows MoP particle size distribution in aqueous solutions of MoP-15, MoP-30, MoP-60, and C-MoP.

FIG. 13 is a powder X-ray diffractogram of C-MoP and MoP-60.

FIG. 14 is a powder X-ray diffractogram showing broadening of MoP peaks after ball milling of C-MoP for 60 min.

FIG. 15 shows cyclic voltammograms of C-MoP, MoP-15, MoP-30, MoP-40, and MoP-60.

FIG. 16 shows linear voltammograms of C-MoP, MoP-15, MoP-30, MoP-40, and MoP-60.

FIG. 17 is a Tafel plot of MoP-60.

FIG. 18 is a gas chromatogram of MoP-60.

FIG. 19 shows the amperometric graph of MoP-60 coated electrode in sulfate buffer solution (pH 1) over a period of 19 hours.

### DETAILED DESCRIPTION

The present invention is directed to a novel synthesis of an HER catalytic material containing molybdenum oxide and graphene. The novel energy efficient technique involves simultaneous reduction of a molybdenum salt and graphite oxide into a molybdenum metal oxide dispersed graphene, and provides a green and economic route for large scale synthesis of a molybdenum oxide/graphene composite catalyst.

The MoO₂ dispersed graphene material is obtained by a chemical free, single step co-reduction of ammonium tetrathiomolybdate (ATM) and graphite oxide (GO). A localized thermal irradiation of ATM-GO composite simultaneously reduces ATM into molybdenum oxide and GO into graphene.

Synthesis of MoO₂/Graphene

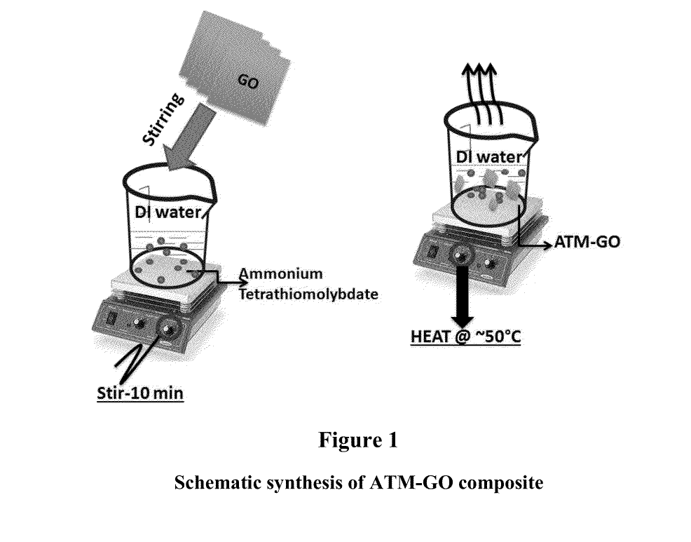

According to one embodiment of the invention, MoO₂/graphene is prepared by co-reduction of ammonium tetrathiomolybdate (ATM) and graphite oxide (GO) using focused solar radiation. FIG. 1 is a series of illustrations shows the steps in making an ATM-GO complex. First, ATM and GO were mixed together in deionized (DI) water as the solvent using ultra sonication and magnetic stirring. It should be understood that the ATM and GO can be mixed together in any solvent (e.g., polar organic solvent, water), such as ethanol, methanol, mixture of water and an alcohol, etc. The limitation on the choice of solvent is the ability to remove substantially of the solvent prior to the next step. The inventors have followed this reaction using different ratios of ATM and GO.

Next, the resulting ATM-GO composite was isolated by evaporating the solvent under slow heating in air at ˜50° C. and grinding the dry powder using mortar. The resulting ATM-GO composite was spread in a petri dish and kept under focused light using a convex lens of 100 mm diameter. The rapid pulses of light were absorbed by the material and transmitted as heat. The localized thermal excitation of the ATM-GO composite rapidly increases the reaction temperature, resulting in simultaneous reduction of GO to SEG and ATM to MoO₂. The conversion of the ATM-GO composite to MoO₂/graphene occurs spontaneously and is without a time lag between the irradiation of sun light and reduction of the composite.

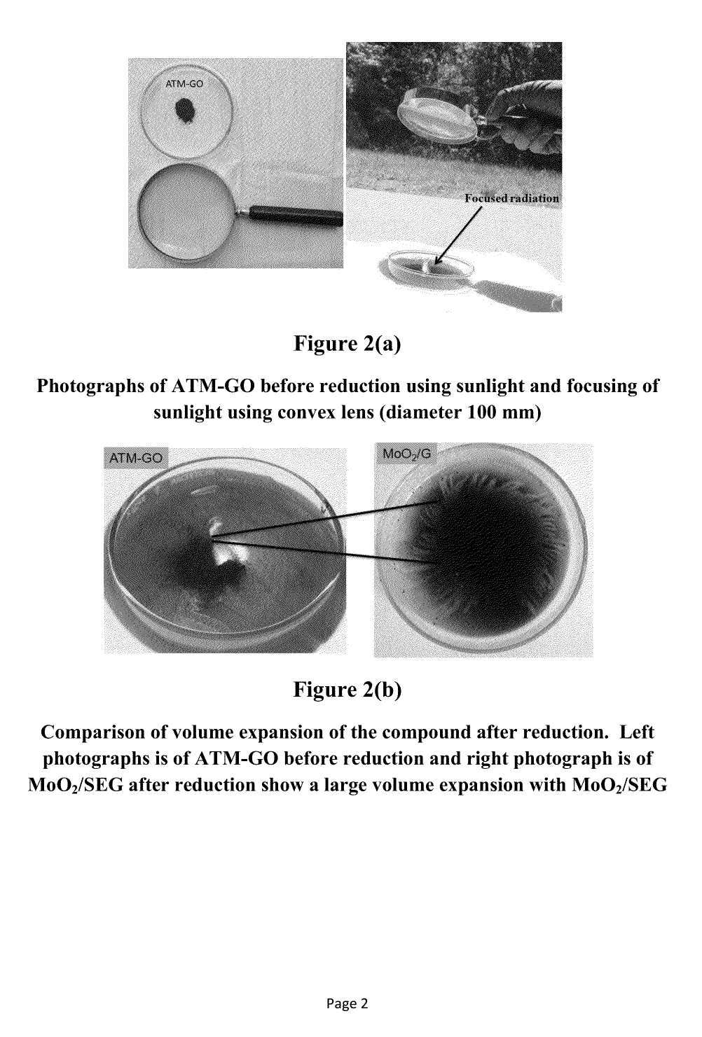

FIGS. 2(a) and 2(b) provide pictorial evidence of the co-reduction of an ATM-GO composite to MoO₂/SEG. FIG. 2(a) illustrates focusing of sunlight on the ATM-GO composite using a convex lens. FIG. 2(b) illustrates the large volume expansion during the reduction. Pure ATM is reduced using focused solar radiation to MoO₂ and pure GO is reduced to SEG (solar exfoliated graphene). These figures demonstrate the simplicity in making the MoO₂/SEG material.

It should be understood that the process of irradiating the ATM-GO composite to MoO₂/SEG can be accomplished in numerous methods that are readily apparent to one of skill in the art. For example, the ATM-GO composite can be placed on a surface of a moving conveyor and solar collectors used to focus sunlight on the ATM-GO composite on the conveyor. The speed of the conveyor can be controlled as a function of the intensity of the sunlight. Alternatively, light of the desired wavelength and a constant intensity can be focused on the ATM-GO composite to cause the co-reduction. One of skill in the art would know to vary the thickness of the layer of ATM-GO composite to optimize conversion to MoO₂/SEG.

Following is an explanation of data generated from the MoO₂/SEG material produced using the reaction above. The data is provided below to demonstrate that the synthesis described above provides the desired MoO₂/graphene material which may be used as a catalyst for generating hydrogen.

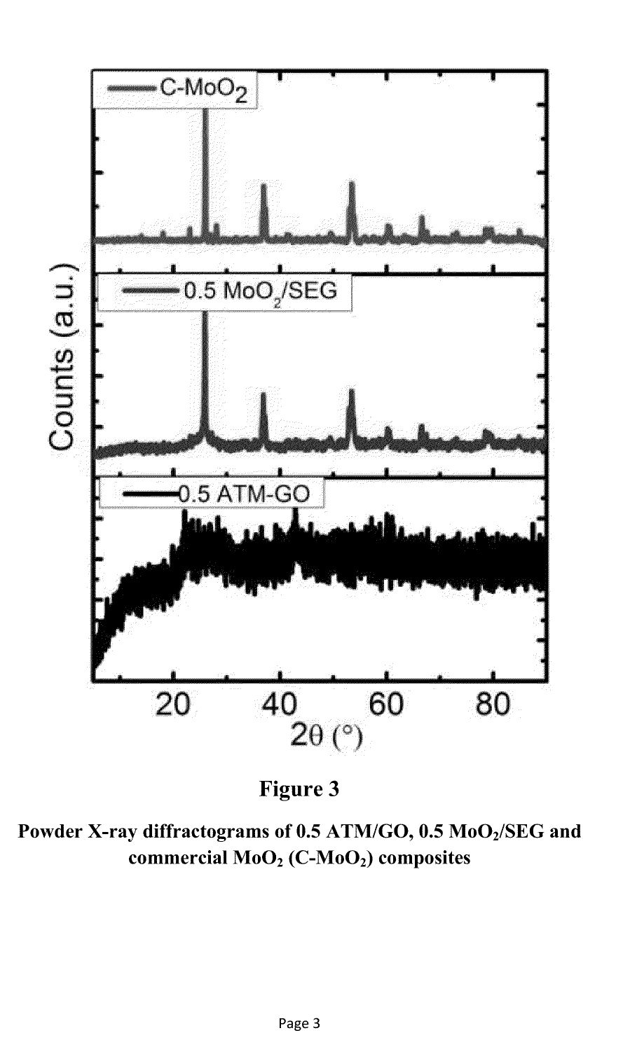

FIG. 3 shows powder X-ray diffractograms of an ATM-GO composite prepared by mixing ratios (0.5) of ATM and GO in a 0.5 ratio, and of the resulting 0.5 MoO₂/SEG product producing according to the co-reduction synthesis described above. The XRD pattern of commercial MoO₂ is also compared. The XRD pattern of the 0.5 ATM-GO composite does not show any crystallographic peaks, whereas the reduced 0.5 MoO₂/SEG product exhibits specific crystallographic peaks corresponding to MoO₂. The peaks in the 0.5 MoO₂/SEG product match with the monoclinic MoO₂ structure (Ref. code: 98-001-7724) and also match with that of commercial MoO₂ shown. The peak at ˜26° (20 value) corresponds to both graphene and MoO₂. The peak exhibits a broad reflection from carbon layers. This diffractogram is evidence that the product resulting from the synthesis is MoO₂/SEG.

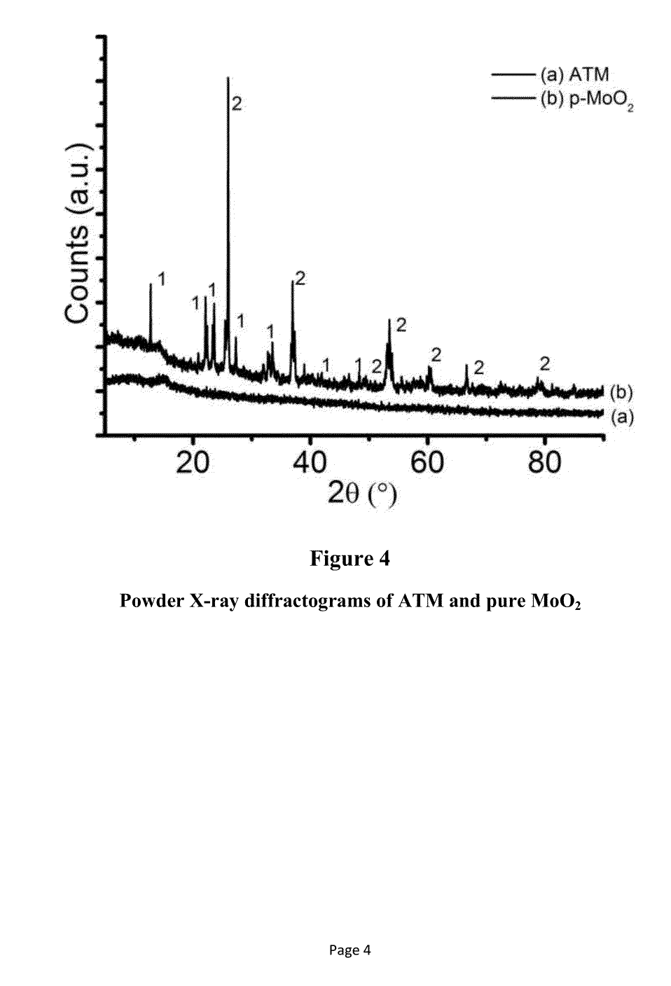

FIG. 4 compares the XRD patterns of pure ATM and pure MoO₂ obtained by solar irradiation of the pure ATM. The figure shows that the XRD of pure ATM does not exhibit any crystallographic orientations, while the same compound after solar irradiation exhibits a number of peaks corresponding to molybdenum dioxide (2) and molybdenum oxide monohydrate (1). Comparison of FIG. 3 and FIG. 4 shows that the XRD of reduced 0.5 MoO₂/SEG product exhibits peaks exclusively corresponding to molybdenum dioxide. The absence of molybdenum oxide hydrate peaks in 0.5 MoO₂/SEG points to formation of single phase of MoO₂ in the presence of graphene. Again, this diffractogram is evidence that the product resulting from the synthesis described herein is MoO₂/SEG.

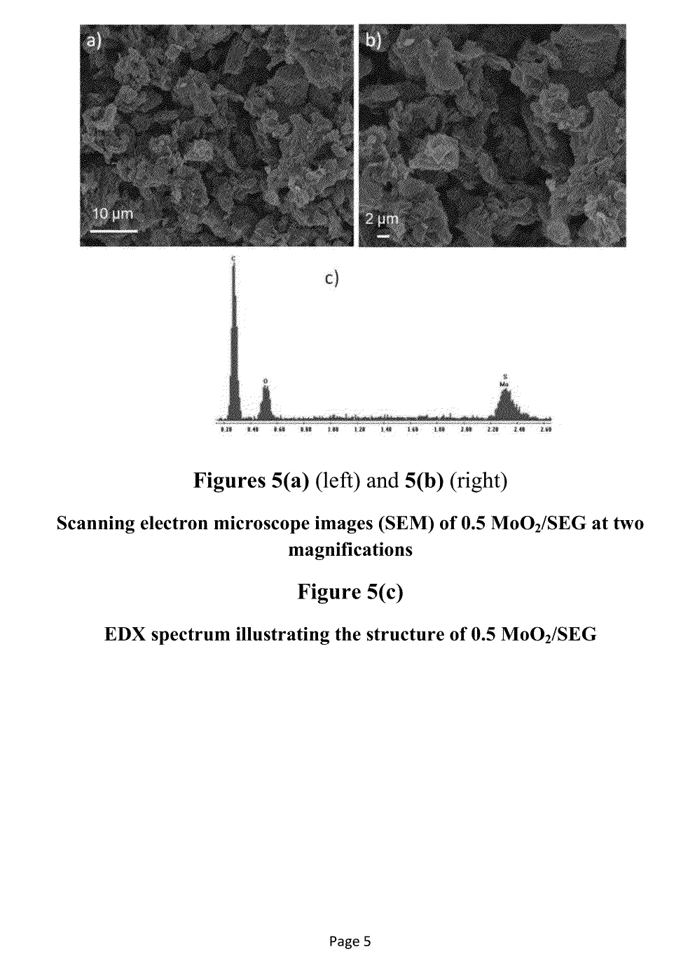

FIG. 5 shows the morphology of the 0.5 MoO₂/SEG product made according to the synthesis described herein. The morphology is reporting using a scanning electron microscope (SEM). The scanning electron microscope image of 0.5 MoO₂/SEG shows thin layers of graphene (FIG. 5(a)) unlike the thick flake like structure of GO reported in literature. The graphene layers can be seen as embedded with MoO₂ particles, substantiating the successful formation of the compound using the current technique. Even though EDX analysis (FIG. 5(c)) shows the presence of sulfur in addition to Mo and O₂, the XRD confirms the exclusive formation of MoO₂. Sulfur analysis performed shows the sulfur content in 0.5 MoO₂/SEG to be 10%. It should be understood that some amount of sulfur will be present as a result of its presence in the ATM starting material.

The exfoliation of thick GO flakes to thin graphene layers is further confirmed by BET surface area measurements. Table 1 provides BET surface area measurements for 0.5 ATM/GO and the resulting 0.5 MoO₂/SEG formed by co-reduction of the 0.5 ATM/GO. The BET value of 251.43 m²/g for 0.5 MoO₂/SEG can be attributed to exfoliation of thick GO flakes to thin graphene layers, corroborating the co-reduction process described above. The very high surface area of the 0.5 MoO₂/SEG compound is responsible, at least in part, for its improved catalytic activity.

TABLE 1
BET surface area of 0.5 ATM/GO and 0.5 MoO₂/SEG

| Material | BET surface area (m²/g) |
|---|---|
| 0.5 ATM/GO | 24.376 |
| 0.5 MoO₂/SEG | 251.43 |

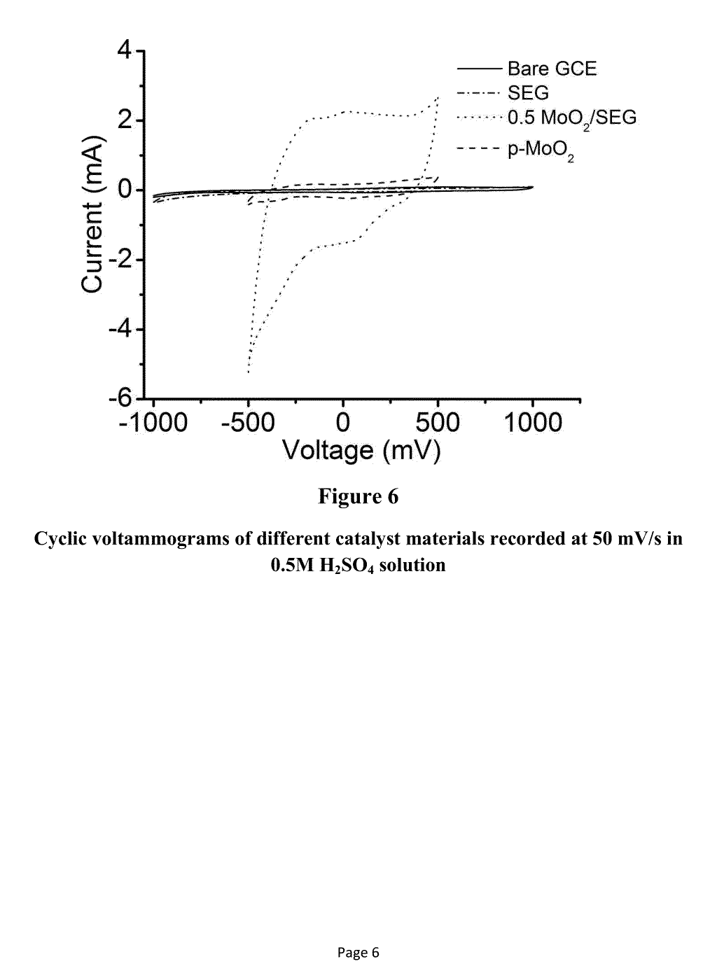

FIG. 6 shows cyclic voltammograms (CV) of bare glassy carbon electrode (GCE) and GCE coated individually either with solar exfoliated graphene (SEG), pure MoO₂, and 0.5 MoO₂/SEG vs. Ag/AgCl, at 50 mV/s scan rate, in 0.5 M H₂SO₄. Of note from FIG. 6 is the high slope of the curve in the region of approximately −250 mV to −500 mV. As the voltage is increased from −250 mV to −500 mV, there is a large increase in the amount of current produced. This is desirable for an efficient catalyst because the increase in current produced directly corresponds to the amount of hydrogen generated.

Table 2 provides current measurements at 400 mV potential for different electrodes. The various catalysts are affixed to a bare glassy carbon electrode (GCE). The table shows that the current decreases in the order of 0.5 MoO₂/SEG>pure MoO₂>pure SEG>GCE, demonstrating the superior electro catalytic activity of 0.5 MoO₂/SEG over pure MoO₂ and pure graphene.

TABLE 2
Current values of different electrodes at 400 mV potential

| Electrode | Current @ 400 mV (mA) |
|---|---|
| Bare GCE | −0.063 |
| SEG/GCE | −0.072 |
| Pure MoO₂/GCE | −0.32 |
| 0.5 MoO₂/GCE | −3.62 |

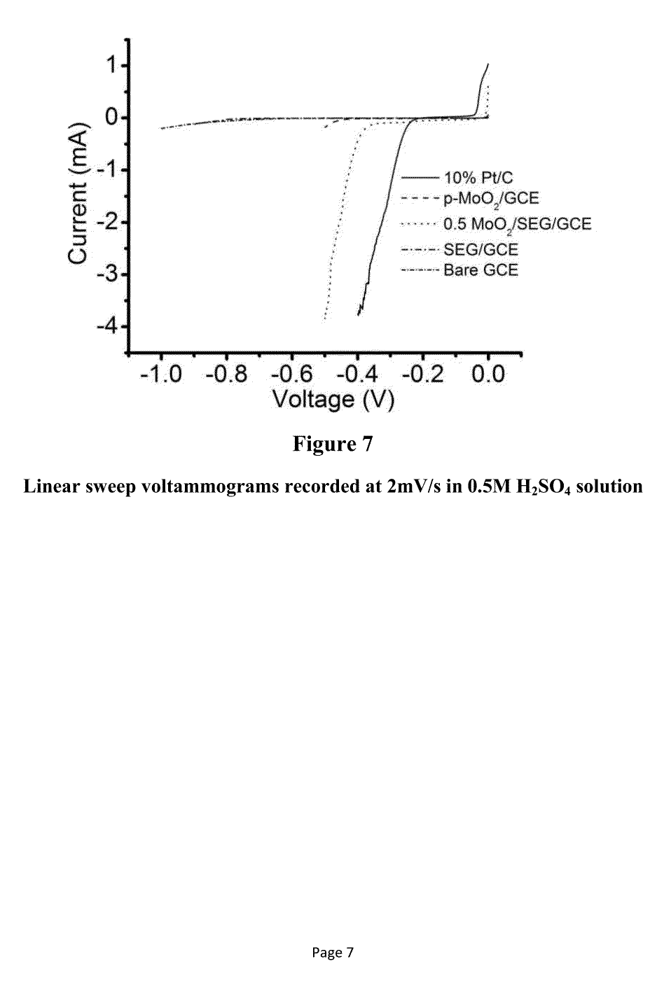

Steady state polarization curves were measured to evaluate the HER catalytic activity of different electrodes versus Ag/AgCl in 0.5 M H₂SO₄ solution at 2 mV/s scan rate. FIG. 7 compares the polarization graphs of electrodes with different HER catalytic materials against commercial 10% Pt/C. The figure shows that the catalytic activity follows the following increasing order: Bare GCE<SEG/GCE<pure MoO₂<0.5 MoO₂/SEG<10% Pt/C. The figure shows that the onset potential for 10% Pt/C and 0.5 MoO₂/SEG at 10 mA/cm² current density are −278 mV and −400 mV, respectively. Even though the onset potential for MoO₂/SEG is higher by 122 mV, it is substantially more preferred for general commercial applications than the platinum material because of the ready availability and lower cost of MoO₂/SEG. After the Pt catalyst, the combination of the MoO₂ and graphene catalyst gives the best performance compared to pure MoO₂ and pure SEG. The HER current density is greater for 0.5 MoO₂/SEG than for pure MoO₂ and pure SEG. FIG. 7 also shows a desirable slope for the 0.5 MoO₂/SEG catalyst. The slope of the LSV is very similar for the 0.5 MoO₂/SEG catalyst and the 10% Pt catalyst, although the onset potentials are different.

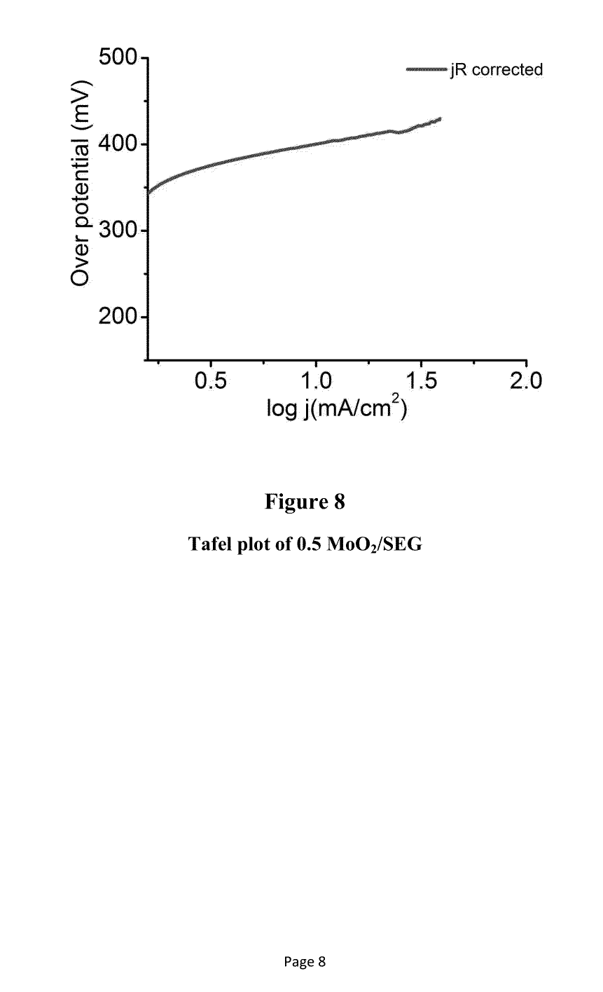

FIG. 8 provides the Tafel plot for 0.5 MoO₂/SEG. The calculated Tafel slope from the curve is 47 mV/dec. The low Tafel slope of 47 mV/dec is an indication of fast reaction kinetics.

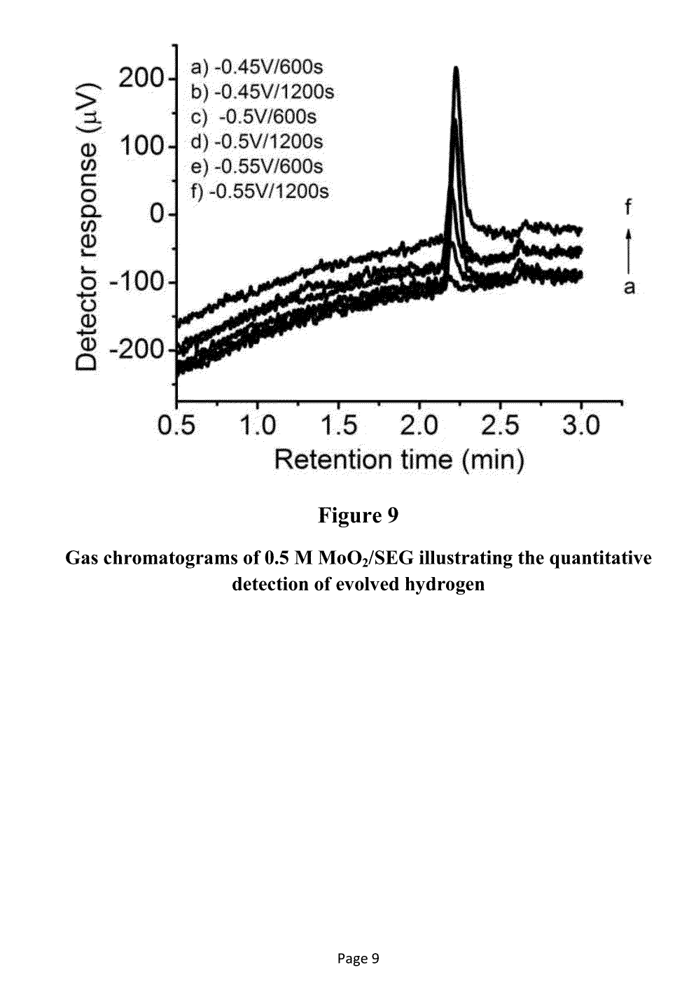

FIG. 9 reports gas chromatograms recorded at different operating potentials and time using the MoO₂/SEG coated electrode. Evolution of hydrogen was confirmed using gas chromatography. The evolution of hydrogen gas was found to start at about −0.35 V.

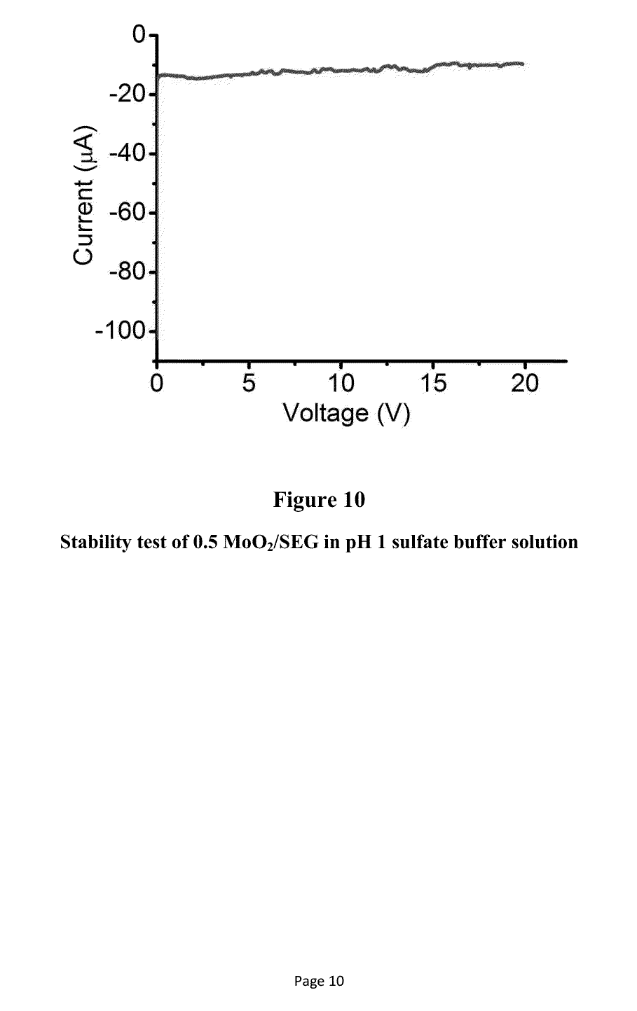

FIG. 10 provides an amperometric analysis of a 0.5 MoO₂/SEG coated electrode in sulfate buffer solution (pH 1) over a period of −20 hours. The figure shows that the electrode performance is reduced by 29.9% over a period of 10 hours, indicating that the catalyst is suitable for extended hours of operation under acidic conditions without significant deterioration in its performance. This enhanced stability of a 0.5 MoO₂/SEG coated electrode is due to the high surface area of the 0.5 MoO₂/SEG catalyst, enhancing its absorption over the electrode surface even when less material is used.

As noted above, in a variation of the MoO₂/SEG catalyst prepared by irradiating ATM/GO, a related molybdenum catalyst can be prepared in the same manner with the difference being use of ammonium hepta molybdate in place of ammonium tetra thiomolybdate (ATM). The resulting compound is termed 0.5 MoO₂/SEG-H. Of note, because the ammonium hepta molybdate is free of sulfur, the resulting 0.5 MoO₂/SEG-H catalyst is likewise free of sulfur.

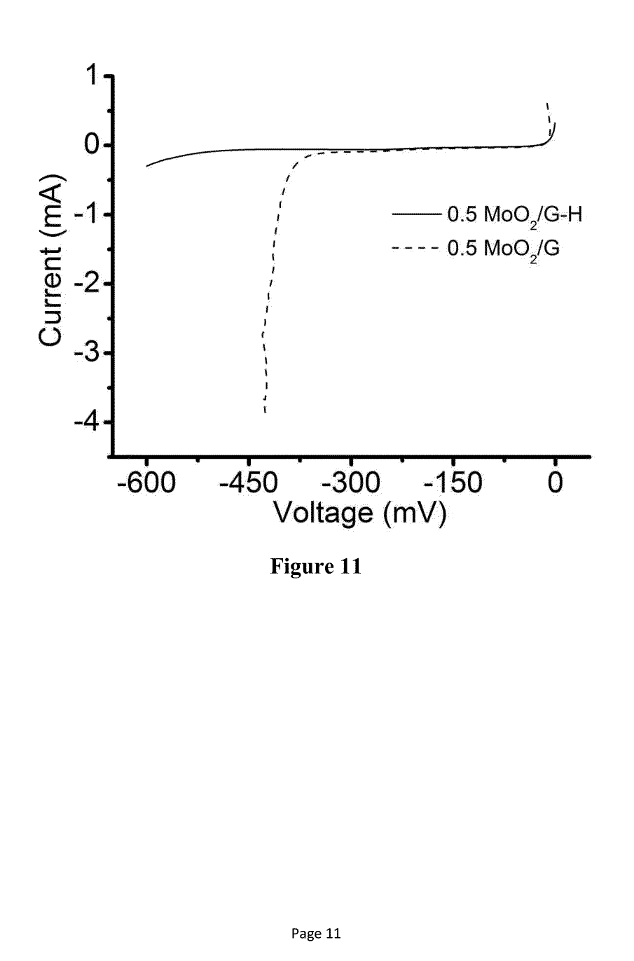

FIG. 11 compares linear sweep voltammograms of a 0.5 MoO₂/SEG complex and a 0.5 MoO₂/SEG-H complex recorded at 2 mV/s scan rate. The figure shows a decrease in onset potential and an increase in hydrogen evolution performance for the 0.5 MoO₂/SEG complex compared to 0.5 MoO₂/SEG-H complex. The onset reduction potential of 0.5 MoO₂/SEG complex containing sulfur towards hydrogen evolution is very low (˜−0.34 V). Also, a large current improvement associated with 0.5 MoO₂/SEG prepared using ammonium tetra thiomolybdate precursor, explains an enhanced effect with sulfur in 0.5 MoO₂/SEG complex.

Table 3 compares the onset reduction potential and Tafel slope for various molybdenum based catalyst materials reported for HER.

TABLE 3
Onset reduction potential and Tafel Slope for Molybdenum based catalyst
materials

| | | Onset reduction | | |
|---|---|---|---|---|
| | | potential, | Tafel slope | |
| Material | Method of preparation | V (vs RHE) | (mV/dec) | Reference |
| MoO₃-MoS₂ | Hotwire CVD method | −0.15 to −0.2 | 50-60 | 1 |
| nanowire | | | | |
| Commercial | | 0.094 | −138 | 2 |
| MoO₃ | | | | |
| MoO₃ | (NH₄)₆Mo₇O₂₄4H₂O and | 0.097 | −116 | 2 |
| nanowire | CTAB-dissolved in | | | |
| | water (30 min stir); add | | | |
| | HNO₃; microwave | | | |
| | heating 150° C. for 3 h; | | | |
| | heat in autoclave at | | | |
| | 180° C. for 20 h; filter, | | | |
| | wash, dry @ 100° C. | | | |
| MoS₂/RGO | (NH₄)₂MoS₄ mixed with | −0.1 | 41 | 3 |
| | GO in DMF. Add | | | |
| | hydrazine, sonication (30 min). | | | |
| | Heat at 200° C. for | | | |
| | 10 h. Centrifuge, | | | |
| | washing, lyophilization. | | | |
| MoS₂/WC/R | Mix WC with GO in | −0.11 | 106 | 4 |
| GO | DMF/water solution. | | | |
| | Solvothermal reaction of | | | |
| | (NH₄)2MoS₄ and | | | |
| | hydrazine in the co- | | | |
| | catalyst solution at | | | |
| | 210° C. for 18 h | | | |
| 0.5 MoO₂/G | Mix GO and | −0.12 | 47 | Present |
| | (NH₄)₂MoS₄ in water, | | | study |
| | stir. Dry at 50° C. | | | |
| | Exposed to sunlight | | | |
| | using convex lens. | | | |
| | Instantaneous reduction | | | |
| | process. | | | |

The references from Table 3 above are the following:
1. Z. Chen, D. Cummins, B. N. Reinecke, E. Clark, M. K. Sunkara, and T. F. Jaramillo, Nano Lett. 2011, 11, 4168-4175.
2. A. Phuruangrat, D.J. Ham, S. Thongtem, J.S. Lee, Electrochem. Commun., 2009, 11, 1740-1743.
3. Y. Li, H. Wang, L. Xie, Y. Liang, G. Hong, and H. Dai, J. Am. Chem. Soc. 2011, 133, 7296-7299.
4. Y. Yan, B. Xia, X. Qi, H. Wang, R. Xu, J. Wang, H. Zhang and X. Wang, Chem. Commun., 2013, 49, 4884-4886.

Synthesis of MoP Catalyst with Reduced Particle Size

As explained above, the inventors have surprisingly determined that commercially available molybdenum phosphide catalysts can be used as a HER catalyst. However, the inventors found that to improve the efficiency of the catalyst, a reduction in particle size was necessary. To reduce the particle size, commercially available MoP catalyst was loaded into a tungsten carbide (WC) ball mill container with WC balls and milled for about 15 minutes to about 90 minutes. One source of a suitable MoP catalyst for ball milling is Alfa Aesar.

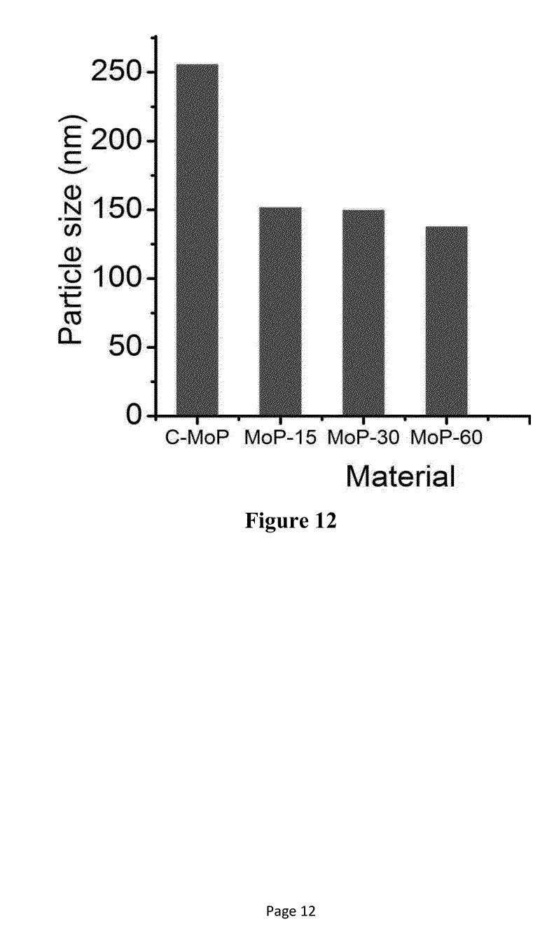

The particle size of the various ball milled MoP materials was determined using a particle size analyzer. FIG. 12 shows the distribution of MoP particle size in an aqueous solution based on the amount of time spent in the ball mill. Without ball milling, the MoP particles had a particle size of about 250 nm Ball milling for about 15 and 30 minutes reduced the particle size to about 150 nm Ball milling for about 60 minutes reduced the particle size to about 140 nm. A particle size of less than about 200 nm is desirable. A particle size of less than about 150 nm is preferred. Provided below is particle size data determined using the dynamic light scattering (DLS) technique using a 90 Plus Particle Size Analyzer, Brookhaven Instruments Corporation:

| | Particle Size |
|---|---|
| Material | (nm) |
| C-MoP | 256 |
| MoP-15 | 152 |
| MoP-30 | 150 |
| MoP-60 | 138 |

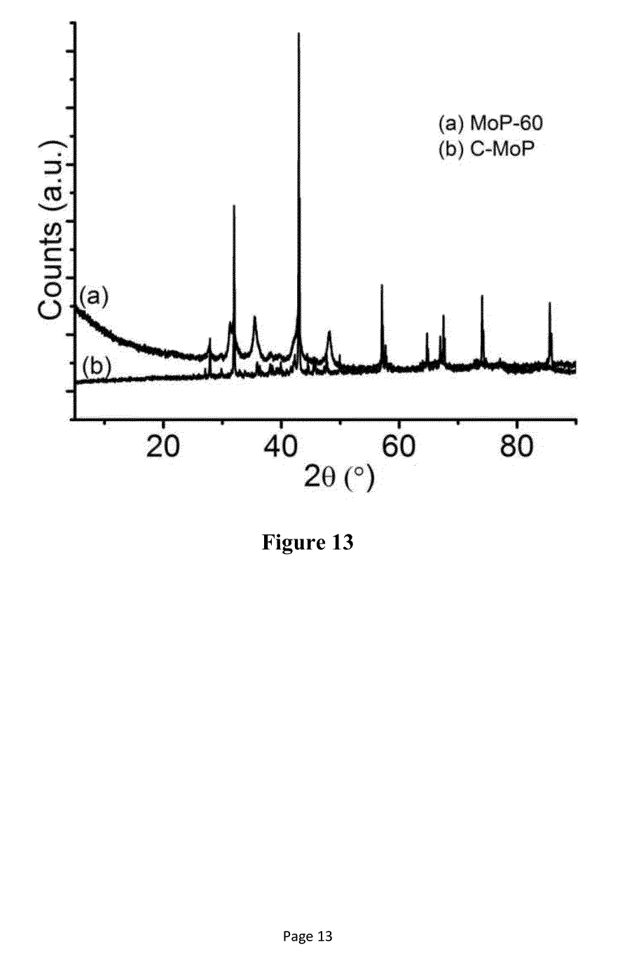

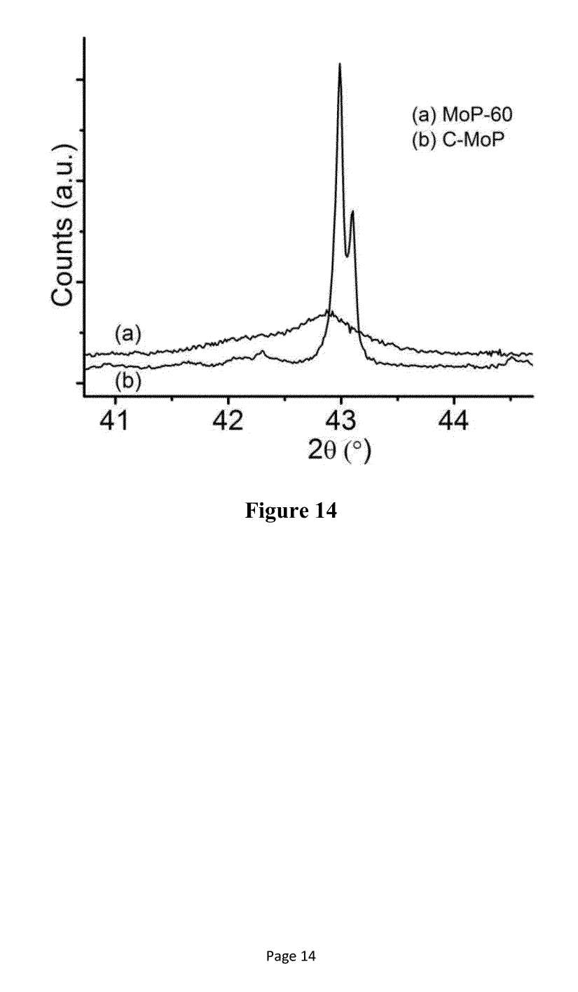

FIGS. 13 and 14 compare the powder X-ray diffractograms of commercial MoP (C-MoP) and MoP-60 (C-MoP ball milled for 60 min) FIG. 14 depicts the broadening of XRD peaks in MoP-60 compared to C-MoP in a narrow range of angle. This broadening of peaks for MoP-60 is attributed to the reduction in particle size of the catalyst during its ball milling for 60 minutes.

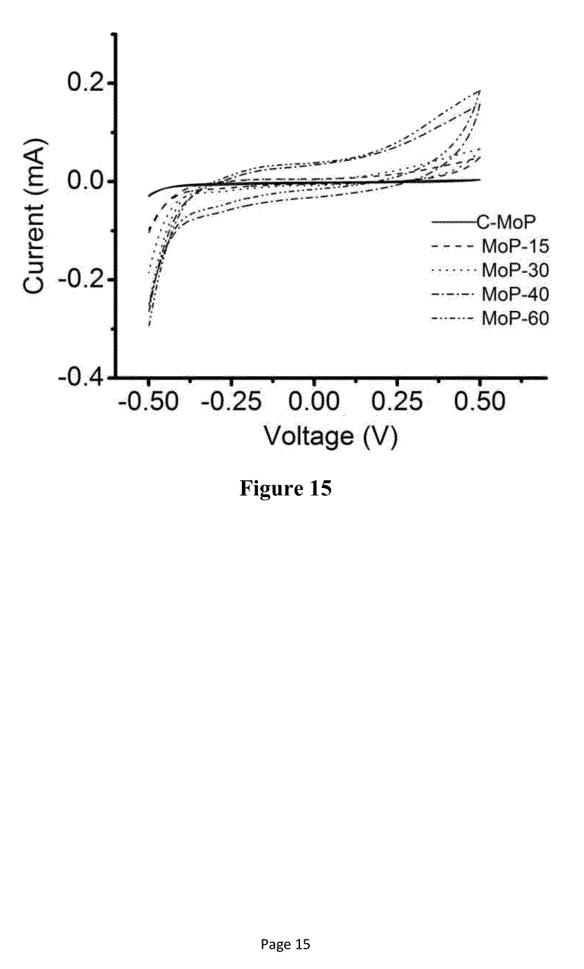

FIG. 15 compares the cyclic voltammograms of C-MoP, MoP-15, MoP-30, MoP-40, and MoP-60. Electrochemical characterization of MoP by cyclic voltammograms shows the following increasing trend in current response: C-MoP<MoP-15<MoP-30<MoP-40<MoP-60. The above increasing trend in current response is related to the increase in surface area of the catalyst during milling, which consequently increases the electron transfer during reduction process leading to increased hydrogen evolution. The trend shows that a reduction in particle size improves the compound's use as a catalyst.

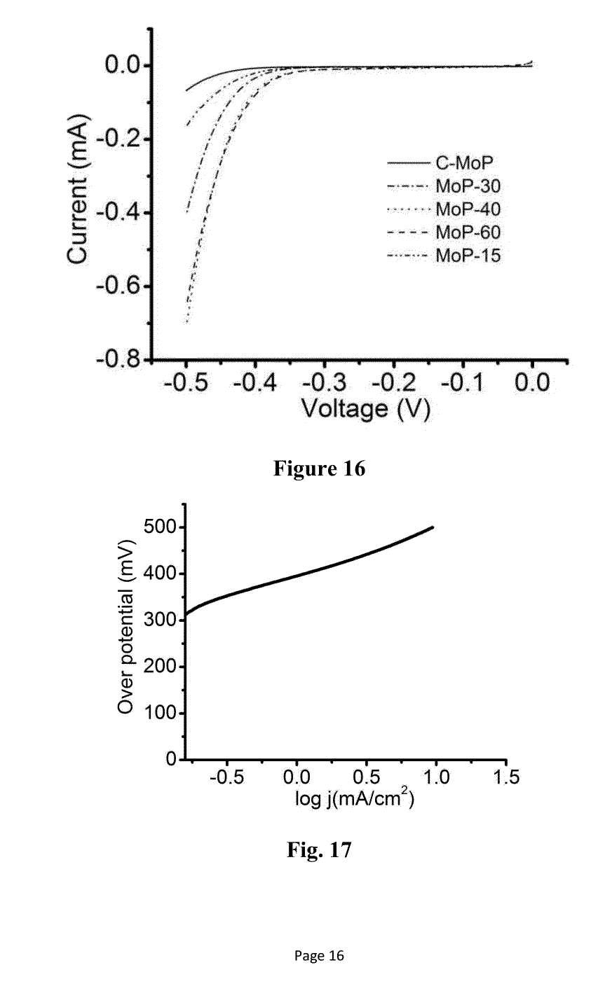

FIG. 16 compares linear sweep voltammograms of MoP catalyst compounds recorded at 2 mV/s scan rate. The MoP catalyst compounds differ in particle size reduction time and therefore particle size. The figure depicts a decrease in onset potential and an increase in hydrogen evolution performance of ball milled compounds with increased ball milling time. The onset reduction potential decreases in the following order: MoP-60>MoP-40>MoP30>MoP-15>C-MoP. The decrease in onset potential and improved current response confirmed the superiority of MoP-60 over other MoP compounds that were ball milled for less time.

FIG. 17 provides the Tafel plot for the MoP-60 catalyst compound. The calculated Tafel slope from the curve is 84 mV/dec. The low Tafel slope of 84 mV/dec is an indication of fast reaction kinetics.

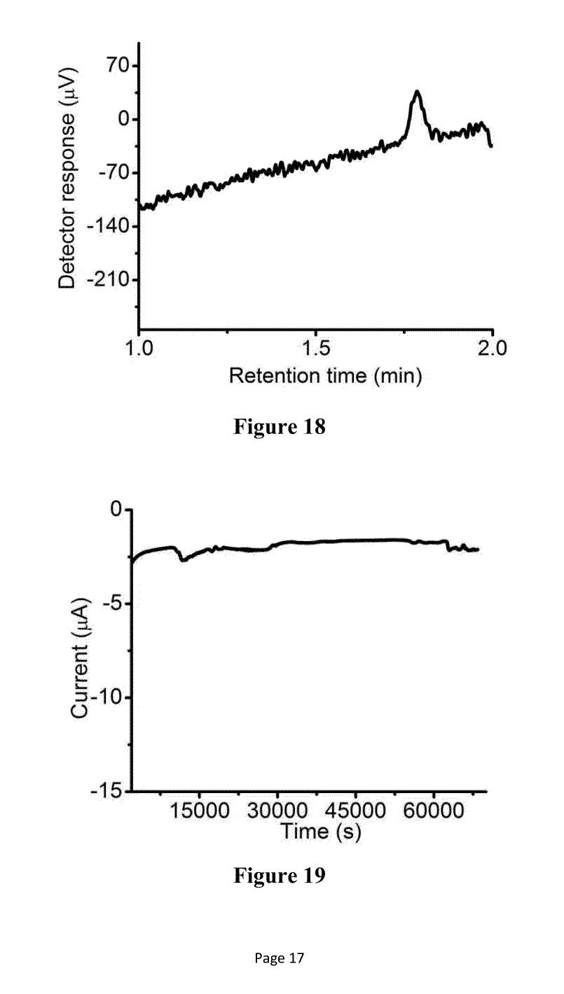

FIG. 18 reports gas chromatogram recorded at different operating potentials and time in the presence of the MoP-60 catalyst. Evolution of hydrogen was confirmed using gas chromatography. The peak in the graph corresponds to the considerable evolution of hydrogen gas during the electrochemical reduction.

FIG. 19 provides an amperometry plot at 0.35 V for MoP-60 catalyst. The plot is recorded over a 19 hour period in a sulfate buffer solution (pH 1). The figure shows high stability of MoP-60 as it results in a small degradation in current (25.8%) over the 19 hour period. This high stability of MoP-60 further validates its usage as a hydrogen evolution reaction catalyst material with a low over potential.

While several particular forms of the invention have been illustrated and described, it will be apparent that various modifications and combinations of the invention detailed in the text and drawings can be made without departing from the spirit and scope of the invention. For example, all metal and metal oxides can be dispersed over graphene for hydrogen production; metal salts of HER catalysts such as Pt, Pd, Ru, Ir, Ni, Au, Ag, Co, Fe, W, Cu, and Mo can be reduced in their pure form or mixed with GO to produce a metal/metal oxide or metal/metal oxide/graphene by this method; salts of Ti can be reduced to TiO₂ for photo catalytic splitting of water; chlorides, nitrates, or sulfides can be reduced to metal/metal oxides; and sulfides of metals can be produced under vacuum employing the same technique.

Similarly, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A process for making a platinum-free metal oxide/graphene catalyst by simultaneous reduction of a metal salt and a graphite oxide into a metal oxide and graphene, the process comprising:
(a) mixing the metal salt and the graphite oxide (GO) in a solution to form a metal salt-GO composite; and
(b) irradiating the metal salt-GO composite with solar light to spontaneously form the metal oxide/graphene catalyst.

2. The process of claim 1, further comprising isolating the metal salt-GO complex by removing the solvent and grinding the resulting dry powder.

3. The process of claim 2 wherein the solvent is removed by heating in air at ˜50° C.

4. The process of claim 1, wherein the focused solar light is obtained using a convex lens of about 100 mm diameter.

5. The process of claim 1, wherein the conversion of metal salt-GO composite to metal oxide-graphene occurs spontaneously and with no time lag between the irradiation of sunlight and reduction of the composite.

6. The process of claim 1, wherein the metal salt is ammonium tetrathiomolybdate (ATM).

7. The process of claim 1, wherein the metal salt is ammonium heptamolybdate.

8. The process of claim 6, wherein graphite oxide is reduced to graphene.

9. The process of claim 8, wherein the graphene is obtained as solar exfoliated graphene.

10. The process of claim 1, wherein the metal salt-GO composite is an ATM-GO composite.

11. The process of claim 10, wherein the ATM-GO composite is reduced to a 0.5 MoO₂/SEG complex.

12. The process of claim 11, wherein the MoO₂/SEG complex contains trace amounts of sulfur.

13. The process of claim 1, wherein the metal salt-GO composite is an ammonium heptamolybdate-GO composite.

14. The process of claim 13, wherein the ammonium heptamolybdate-GO composite is reduced to a 0.5 MoO₂/SEG-H complex.

15. The process of claim 14, wherein 0.5 MoO₂/SEG-H complex is free of sulfur.

16. The process of claim 1, wherein the solvent is water.

17. A method of generating hydrogen, the method comprising using MoO₂/SEG as a catalyst in a cathode used for generating hydrogen.

18. A process for increasing the catalytic activity of a MoP (C-MoP) catalyst for providing generation of hydrogen, the process comprising ball milling C-MoP in a ball mill to reduce the particle size of the MoP.

19. A method of generating hydrogen, the method comprising using MoP having a particle size of less than 200 nm as a catalyst in a cathode.

20. The method of claim 19, wherein the MoP has a particle size of less than about 150 nm.
